(19) United States
(12) Patent Application Publication
(10) Pub. No.: US 2026/0158943 A1
(43) Pub. Date: Jun. 11, 2026

(54) CHARGING ADAPTER FOR VEHICLE

(71) Applicants: Hyundai Motor Company, Seoul (KR); Kia Corporation, Seoul (KR); KYUNGSHIN CO., LTD., Incheon-si (KR)

(72) Inventors: Sam Gyun LEE, Hwaseong-Si (KR); Je Hyun KIM, Hwaseong-Si (KR); In Hyeok CHOI, Incheon (KR); Seung Deuk AHN, Incheon (KR)

(21) Appl. No.: 19/287,144

(22) Filed: Jul. 31, 2025

(30) Foreign Application Priority Data
Dec. 11, 2024 (KR) 10-2024-0183540

(51) Int. Cl. B60L 53/16; B60L 53/31; H01R 13/627

(52) U.S. Cl. CPC B60L 53/16; B60L 53/31; H01R 13/6272; H01R 2201/26

(57) ABSTRACT

A charging adapter for a vehicle comprises a connector connection portion configured to receive a charging connector, a latch receiving portion disposed on an outer surface of the connector connection portion, a latch at least partially received in the latch receiving portion and hinge-coupled to the latch receiving portion by a hinge pin, and a spring configured to push a side of the latch away from the latch receiving portion, wherein the latch includes a first portion connected to the spring and a second portion comprising a first protrusion protruding in a first direction toward the connector connection portion, the first portion positioned oppositely to the second portion with respect to the hinge pin, and the first protrusion penetrating the latch receiving portion and the connector connection portion such that an end of the first protrusion fits in a first groove of the charging connector.

### CROSS-REFERENCE TO RELATED APPLICATIONS

This application claims the benefit of Korean Patent Application No. 10-2024-0183540, filed on Dec. 11, 2024, which is hereby incorporated by reference herein in its entirety.

### TECHNICAL FIELD

The present disclosure relates to a charging adapter for a vehicle.

### BACKGROUND

In a wired charging method of connecting an external charger to a vehicle, a charging connector of the charger and a charging port of the vehicle are required to be compatible with each other.

There are various types of charging connectors such as a Combined Charging System (CCS), in which AC and DC charging functions are integrated into a single plug; a North American Charging Standard (NACS), which is developed by Tesla and becomes a standard adopted by the Society of Automotive Engineers (SAE) International as a charging standard; and a CHArge de MOve (CHAdeMO), which is an electric vehicle charger standard developed in Japan. Each of these examples use different types of terminals and are not compatible with each other.

Depending on a charging standard adopted from each country or a charging type provided by an external charger, and which type of a charging connector a charging port of a vehicle is compatible with, there may occur a problem that the vehicle cannot be charged due to the incompatibility between the charging connector and the charging port.

A charging adapter may allow a charging connector and a charging port of different charging schemes and/or standards to be connected. The charging adapter may include a locking device (e.g., a lock) for preventing forced detachment of the charging connector. This locking device may be provided as a sliding type or a rotation type, for example. The locking device may be positioned at a lower side of the charging adapter (e.g., a surface facing the ground when charging adapter is in use with a charging connector and otherwise incompatible charging port). It may be inconvenient for users to check the position of the locking device and/or whether the locking device is in the locked state when using the adapter.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a charging adaptor for a vehicle. A charging adapter for a vehicle may comprise: a connector port that forms a space configured to accept insertion of a charging connector; a latch holder on an outer surface of the connector port; a latch configured to be at least partially received in the latch holder; a hinge pin that hinge-couples the latch to the latch holder; and a spring disposed between a first side of the latch and the latch holder. The latch may comprise: a first portion connected to the spring, and a second portion comprising a first protrusion protruding in a first direction toward the connector port, the first portion positioned oppositely to the second portion with respect to the hinge pin. The first protrusion may be configured to penetrate the latch holder and the connector port, and an end of the first protrusion may be configured to be inserted into a first groove of the charging connector.

A charging adapter for a vehicle may comprise: a connector port that forms a space configured to accept insertion of a charging connector; a latch hingedly fixed to a side of the connector port via a hinge pin having ends inserted in hinge holes formed in the side of the connector port; a spring disposed between a first side of the latch and the side of the connector port, a first protrusion, on a second side of the latch opposite to the first side, protruding in a first direction toward the connector port, wherein the first protrusion is configured to penetrate the connector port, and an end of the first protrusion is configured to be inserted into a first groove of the charging connector; and a second protrusion, on a side of the first protrusion, protruding in a second direction toward a groove formed by the connector port, wherein the hinge holes have a length in the second direction configured to allow the hinge pin to move in the second direction such that the second protrusion is inserted into the groove.

A vehicle may comprise a charging adapter as disclosed herein. For example, a vehicle may comprise a charging adaptor comprising: a connector port that forms a space configured to accept insertion of a charging connector; a latch holder on an outer surface of the connector port; a latch configured to be at least partially received in the latch holder; a hinge pin that hinge-couples the latch to the latch holder; and a spring disposed between a first side of the latch and the latch holder. The latch may comprise: a first portion connected to the spring, and a second portion comprising a first protrusion protruding in a first direction toward the connector port, the first portion positioned oppositely to the second portion with respect to the hinge pin. The first protrusion may be configured to penetrate the latch holder and the connector port, and an end of the first protrusion may be configured to be inserted into a first groove of the charging connector. Also, or alternatively, the charging adapter may: a connector port that forms a space configured to accept insertion of a charging connector; a latch hingedly fixed to a side of the connector port via a hinge pin having ends inserted in hinge holes formed in the side of the connector port; a spring disposed between a first side of the latch and the side of the connector port, a first protrusion, on a second side of the latch opposite to the first side, protruding in a first direction toward the connector port, wherein the first protrusion is configured to penetrate the connector port, and an end of the first protrusion is configured to be inserted into a first groove of the charging connector; and a second protrusion, on a side of the first protrusion, protruding in a second direction toward a groove formed by the connector port, wherein the hinge holes have a length in the second direction configured to allow the hinge pin to move in the second direction such that the second protrusion is inserted into the groove.

These and other features and advantages are described in greater detail below.

### BRIEF DESCRIPTION OF THE DRAWINGS

FIG. 1 is a coupled perspective view of a charging connector and a charging adapter according to an example of the present disclosure.

FIG. 2 is an exploded front view illustrating a charging connector and a charging adapter illustrated in FIG. 1.

FIG. 3 is a front view of a charging connector and a charging adapter coupled to each other and an enlarged view of a latch portion according to an example of the present disclosure.

FIG. 4 is a perspective view illustrating a latch according to an example of the present disclosure.

FIG. 5 is a view illustrating a state in which a charging connector is normally connected.

FIG. 6 is a view illustrating a state in which the charging connector is detachable.

FIG. 7 is a diagram illustrating a case where there is a forced detachment of the charging connector.

FIG. 8 is a diagram comparing a state in which the charging connector is normally connected and a case in which there is an act of forced detachment.

### DETAILED DESCRIPTION

Hereinafter, examples of the present disclosure will be described in detail with reference to the accompanying drawings so that those skilled in the art to which the present disclosure pertains may practice easily the present disclosure. However, the present disclosure may be embodied in many different forms and is not limited to the examples described herein. In order to clearly describe the present disclosure in the drawings, parts irrelevant to the description are omitted, and similar reference numerals refer to similar parts throughout the specification.

The terminology used herein is for the purpose of describing particular examples only and is not intended to be limiting of the present disclosure. Singular expressions include plural expressions unless the context clearly indicates otherwise. In the present application, it should be understood that terms such as “include” or “have” are intended to designate the existence of the features, numbers, steps, operations, components, parts, or combinations thereof described in the specification, and are not intended to preclude the possibility that one or more other features, numbers, steps, operations, components, parts, or combinations thereof may exist or may be added.

Terms such as “portion”, “unit”, “module”, and the like described in the specification mean a unit for processing at least one function or operation, and may be implemented by hardware, software, or a combination of hardware and software.

Terms including ordinals such as “first”, “second” may be used to describe various elements, but the elements are not limited by the terms. The terms may be used only as a name meaning for distinguishing one element from another element, and an order meaning between them is recognized through the context of the corresponding description, not the title.

The term “and/or” is used to cover all instances of any condition of the plurality of items to which it is intended. For example, “A and/or B” includes all three cases such as “A”, “B”, and “A and B”.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

It will be understood that when an element is referred to as being “connected” or “coupled” to another element, it may be directly connected or coupled to the other element without still further elements therein, or else intervening elements may be present.

Unless otherwise defined, all terms used herein, including technical or scientific terms, have the same meanings as those generally understood by those skilled in the art to which the present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, examples of the present disclosure will be described in detail with reference to the accompanying drawings.

For convenience, the description will be made using a Cartesian coordinate system (x-axis, y-axis, and z-axis), but it will be apparent that the description may also be made by other coordinate systems. In addition, according to the Cartesian coordinate system, the x-axis, the y-axis, and the z-axis are orthogonal to each other, but the example is not limited thereto. In other words, the x-axis, the y-axis, and the z-axis may intersect each other.

Here, the x-axis direction may be used as including both +x-axis and −x-axis directions, or may be referred to as meaning any one of the +x-axis and −x-axis directions. This is the same for the y-axis and z-axis.

In an example, the x-axis direction may be a direction in which the charging connector 100 is connected. Here, the connecting direction may include both a mounting direction and a removal direction, and thus the +x-axis direction may be the removal direction of the charging connector 100, and the −x-axis may be the mounted direction of the charging connector 100. In addition, the x-axis direction may be expressed as a second direction.

In an example, the y-axis direction may be a direction parallel to the coupling direction of the hinge pin 300. Alternatively, it may be a direction in which the hinge pin 300 is inserted to the hinge hole 222.

In an example, the z-axis direction may be a protruding direction of the first protrusion 520. The protruding direction of the first protrusion 520 may be a direction in which the charging connector 100, the connector connection portion 210 are positioned on the latch 500 (e.g., the body 510 of the latch 500). The z-direction may be a direction perpendicular to the x-axis direction. Also, the z-direction may be a movement direction of the first protrusion 520 when the latch 500 rotates about the hinge pin 300. Although the first protrusion 520 may perform a rotational motion based on (e.g., around) the hinge pin 300, the range of motion of the end of the first protrusion 520 may not be not wide, so its motion may be approximated as a line tangent to the art or rotation, and thereby expressed as moving in the z-axis direction for convenience. The z-axis direction may be expressed as a first direction.

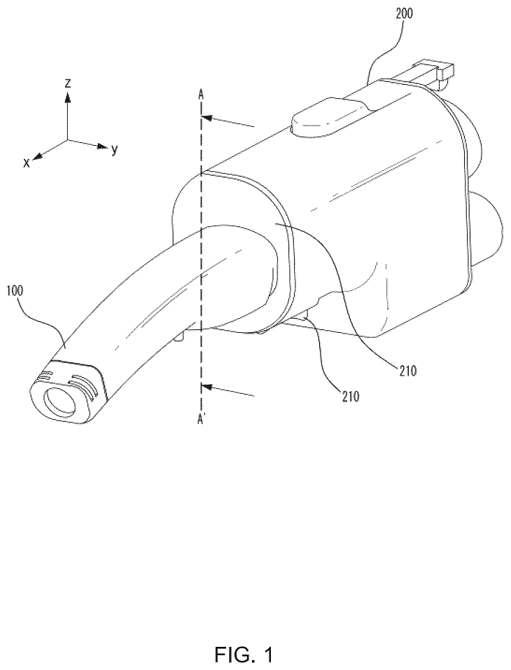

Hereinafter, the separation and coupling of the charging connector 100 and the charging adapter 200, and the latch 500 coupled to the charging adapter 200 according to an example of the present disclosure will be described in reference to FIGS. 1 to 3.

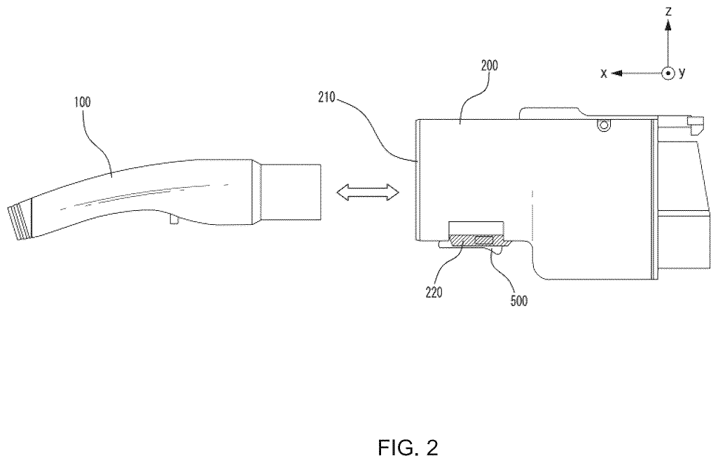

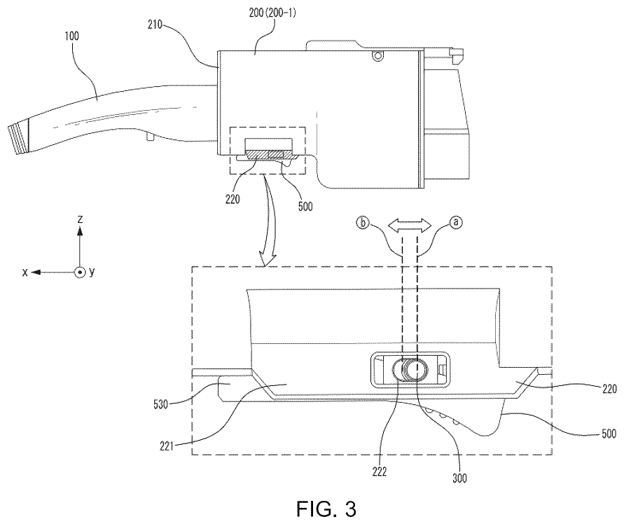

FIG. 1 is a perspective view of a charging connector 100 and a charging adapter 200 according to an example of the present disclosure. FIG. 2 is an exploded front view illustrating the charging connector 100 and the charging adapter 200 shown in FIG. 1. FIG. 3 is a front view of the charging connector 100 and the charging adapter 200 coupled to each other and an enlarged view of a portion of the latch 500 according to an example of the present disclosure.

The charging connector 100 and the charging adapter 200 according to an example of the present disclosure may be connected along the x-axis direction. The charging adapter 200 may include a connector connection portion 210 (e.g., a connector port, a connector receiver) that provides a space in which the charging connector 100 may be received/accommodated to be connected. The charging adapter 200 may include a latch receiving portion 220 (e.g., a latch holder, a latch receiver) disposed on an outer surface of the connector connection portion 210.

The charging adapter 200 may comprise a main body 200-1 receiving various electronic components therein and a connector connection portion 210 coupled to the main body 200-1. The latch receiving portion 220 may be a component integrally formed with the main body 200-1 or additionally coupled to the main body 200-1. The latch receiving portion 220 may be directly coupled to the connector connection portion 210 and/or may be interposed with the main body 200-1. In the present disclosure, the connector connection portion 210 and the latch receiving portion 220 may be referred to as a charging adapter 200. Hereinafter, the charging adapter 200, which is an integrated concept, is used instead of the expression “main body 200-1”.

The connector connection portion 210 may be cylindrical and/or otherwise shaped to receive at least a portion of the charging connector 100 therein.

The charging adapter 200 may comprise, along the x-axis direction, a terminal portion which may be connected to a terminal portion of the charging connector 100.

The latch receiving portion 220 may be disposed on the outer surface of the connector connection portion 210. For example, the latch receiving portion 220 may be disposed on the outer surface in the −z-axis direction (e.g., an outer surface facing the z-axis direction). Accordingly, at least part of the charging connector 100 and at least part of the charging adapter 200 (for example, the connector connection portion 210 and the latch receiving portion 220) may overlap on the z-axis direction (e.g., a theoretical line in the z-axis direction may pass through each of the connector connection portion 210 and the latch receiving portion 220).

At least a portion of the latch 500 may be received/accommodated in the latch receiving portion 220. The latch receiving portion 220 may comprise sidewalls 221 extending along the x-axis direction and the z-direction. The two side walls 221 may be disposed side by side to form a space therebetween. At least a portion of the latch 500 may be disposed in the space formed between the two side walls 221. The latch 500 may be hinge-coupled to the latch receiving portion 220, for example, by the hinge pin 300. At least a portion of the hinge pin 300 may be coupled to the hinge holes 222 formed to penetrate the sidewalls 221 of the latch receiving portion 220 in the y-axis direction.

Each of the hinge holes 222 may have a length extending in the x-axis direction (e.g., be longer in the x-direction than the z-direction) so that the hinge pin 300 may move by a predetermined distance in—the x-axis direction. The hinge pin 300 may be located at position \textcircled{a} in a normal state (e.g., normally connected state), and the hinge pin 300 may be located to position \textcircled{b} when/if the charging connector 100 is forcibly removed.

The latch 500 may be coupled (e.g., indirectly) to the hinge hole 222 by/via the hinge pin. Since the hinge hole 222 has a predetermined length in the x-axis direction, the latch 500 may rotate on the x-z plane or linearly move in the x-axis direction with rotation and/or movement of the hinge pin 300.

A spring 400 may be disposed on a first side of the latch 500 (e.g., a first side in the −x-axis direction). In FIG. 3, the spring 400 may be located in the direction of the −x-axis direction rather than the hinge hole. The spring 400 (not shown in FIGS. 1-3 as the side wall 221 is in the way) may be disposed between the latch 500 and the latch receiving portion 220. The spring 400 may be compressed between a first side of the latch 500 facing the latch receiving portion and the latch receiving portion 220. The compression of the spring 400 may generate a corresponding spring force between the first side of the latch 500 and the latch receiving portion 220. Accordingly, the latch 500 may be rotated about the hinge pin 300 by the hinge pin 300 and the spring 400.

The spring 400 may push on the first side of the latch 500 in the −z-axis direction. As the latch 500 is fixed by the hinge pin, the opposite side of the latch 500 may be thrusted toward the +z-axis direction. However, since the x-axis directional end portion (second protrusion 530 described below) of the latch 500 protrudes toward the outside of the latch receiving portion 220, the second protrusion 530 may be in contact with the outer surface of the charging adapter 200 (e.g., is blocked from further rotation by the outer surface of the charging adapter 200). As such, the second protrusion 530 stops the latch 500 from being further rotated by the spring 400 (e.g., as shown in FIG. 3) in a state in which external compression force in the +z-axis direction is not applied to the spring 400.

If the charging connector 100 is inserted into the connector connection portion 210, the connector connection portion 210 may be positioned between the charging connector 100 and the latch receiving portion 220. The connector connection portion 210, the charging connector 100, the charging adapter (for example, the connector connection portion 210 and the latch receiving portion 220), and the latch 500 may overlap at least partially in the z-axis direction.

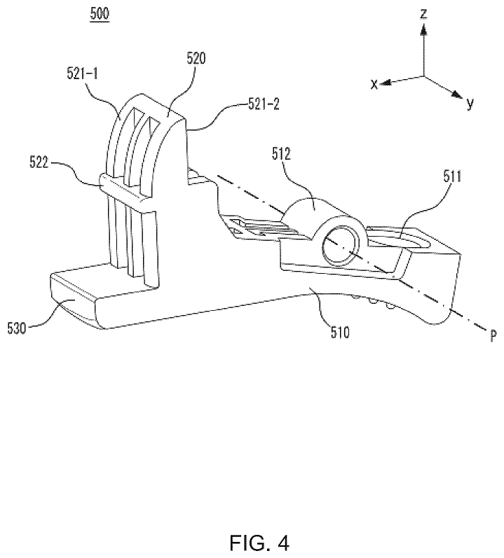

Hereinafter, the latch 500 according to an example of the present disclosure will be described in detail with reference to FIG. 4. FIG. 4 is a perspective view illustrating a latch 500 according to an example of the present disclosure.

The latch 500 largely may include a body 510 having a length extending in the x-axis (e.g., longer in the x-direction than in the z-direction). The body 510 may include a spring fixing portion 511 (e.g., a groove formed in the body 510). For example, the spring fixing portion may comprise a groove to which the spring 400 may be sequentially fixed in the x-axis direction. The body 510 may include/form a rotation shaft hole 512 into which the hinge pin 300 may be inserted. The body 510 may include a first protrusion 520 protruding in the z-axis direction and a second protrusion 530 protruding in the x-axis direction. For example, the spring fixing portion 511 may be located on a first side of the body 510, and the first protrusion 520 and the second protrusion 530 may be located on a second side of the body 510, opposite to the first side relative to the rotation axis hole 512. The rotation shaft hole 512 may be positioned between the spring fixing portion 511 and the first protrusion 520. In order to allow the first protrusion 520 to move more (e.g., relative to the spring fixing portion 511), the rotation shaft hole 512 may be positioned closer to the spring fixing portion 511 than the first protrusion 520.

The rotation shaft hole 512 may be a hole formed by extending a circular cross section in the y-axis direction. The hinge pin 300 may be inserted into the rotation shaft hole 512. Two ends of the hinge pin 300 may extend beyond the ends of the rotation shaft hole 512, and may be disposed inside (e.g., extend into) the hinge hole 222 in the side wall 221 of the latch receiving portion 220. Since the latch 500 may be rotated by the hinge pin 300, the center of the rotation shaft hole 512, into which the hinge pin 300 is inserted, may be parallel to the rotation axis P of the latch 500.

The first protrusion 520 may protrude in a direction in which the connector connection portion 210 is located (e.g., the z-axis direction). The first side surface 521-1, which may be a side surface positioned in the x-axis direction among the side surfaces of the first protrusion 520 (e.g., a side surface facing the charging connector 100 inserted into the charging adapter 200), may have a curved shape. The curved shape may be curved more steeply as the curve of the first side surface 525-1 approaches a second side surface 525-2 (e.g., the opposite side surface). Since the first side surface 521-1 has a curved shape (e.g., as shown in FIG. 4), an external compression force (e.g., applied to by a user) need not be applied to the spring 400 when the charging connector 100 is inserted in the-x-axis direction to insert the charging connector 100 into the charging adapter 200.

When/if the user inserts the charging connector 100 along the-x-axis direction, the charging connector 100 pushes the curved surface of the first side surface 521-1 in the −x-axis direction, and the curved surface partially converts the −x-axis direction force (e.g., applied to insert the charging connector 100) to a force on the first protrusion 520 in the −z-axis direction. The force on the first protrusion 520 results in a +z-axis direction compression force on the spring 400 due to rotation about the hinge pin 300. For example, due to the curved surface of the first side surface 521-1, the user may insert the charging connector 100 into the charging adapter 200 without pressing the latch 500 to apply a pressure to the spring 400.

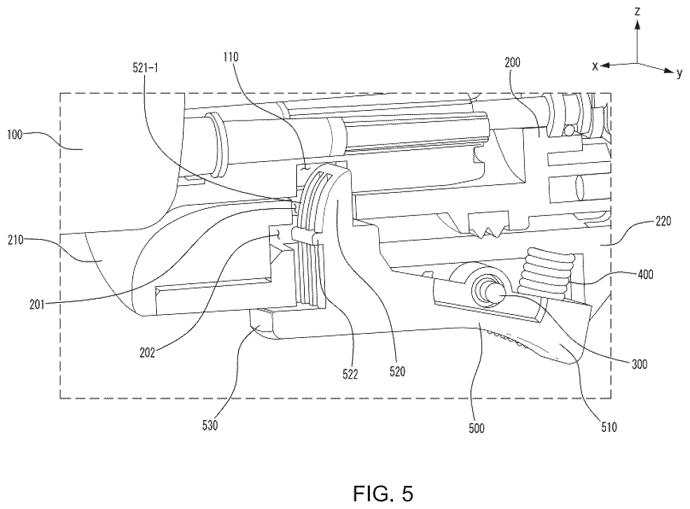

The first protrusion 520 may include a stopper 522 protruding from the first side surface 521-1 in the x-axis direction (e.g., the detaching direction of the charging connector 100). The stopper 522 will be described in detail with reference to FIGS. 5 to 7.

The second protrusion 530 may protrude from the end of the body 510 in the x-axis direction. The second protrusion 530 may be positioned outside the latch receiving portion 220 (e.g., extend beyond the latch receiving portion 220) so as to interact with (e.g., contact) the charging adapter 200 to prevent the other side of the body 510 from further rotating in the z-axis direction.

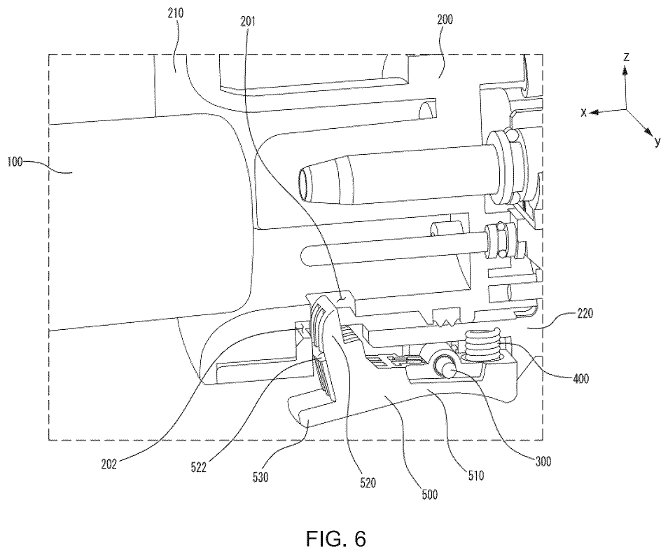

Hereinafter, a function of preventing forcible detachment of the charging connector 100 of the charging adapter 200 according to an example of the present disclosure will be described with reference to FIGS. 5 and 6.

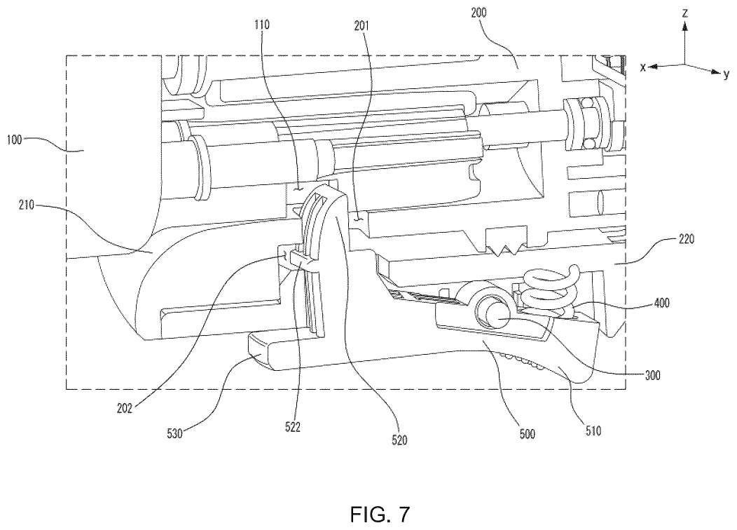

FIGS. 5 to 7 are enlarged cross-sectional views taken along line A-A′ of FIG. 1. FIG. 5 is a diagram illustrating an initial state and/or a state in which the charging connector 100 is normally connected. FIG. 6 is a view illustrating a state in which the charging connector 100 is detachable. FIG. 7 is a view illustrating a case in which the charging connector 100 is forcibly detached.

FIG. 5 is a view illustrating the charging adapter 200 in a state in which no external compression force (e.g., from a user) is applied to the spring 400. Although FIG. 5 illustrates a state in which the charging connector 100 is connected, since no compression force is applied to the spring 400 even in an initial state in which the charging connector 100 is not connected, the state of the latch 500 is the same.

FIG. 6 illustrates a state in which an external compression force is applied to the spring 400, and FIG. 7 illustrates a case in which there is a forced detaching action to remove the charging connector 100 when the external compression force is not applied to the spring 400.

Referring to FIG. 5, since the spring 400 pushes the latch receiving portion 220 and the latch 500 in opposite directions, and the second protrusion 530 is blocked by the charging adapter 200, the latch 500 may be held in place without rotating further about the hinge pin 300. In this state, the first protruding portion 520 may pass through the latch receiving portion 220 and the connector connection portion 210, and an end of the first protruding portion 520 may be coupled (e.g., inserted into) to the first groove portion 110 of the charging connector 100.

The latch receiving portion 220, and the connector connection portion 210 are formed from a same material.

The first protrusion 520 may pass through a penetrating hole 201 in the charging adaptor 200. The charging adapter 200 may form the penetrating hole 201 through which the first protrusion 520 passes. The charging connector 100 may include a first groove 110 in which an end of the first protrusion 520 may be disposed. The first groove 110 may be a groove recessed in the z-axis direction.

The z-axis direction length of the first protrusion 520, which is the protruding length, may be longer than the z-axis direction distance between an inner surface of the connector connection portion 210 and the outer surface of the charging adapter 200. The z-axis direction length of the first protrusion 520 may be shorter than or equal to the z-axis direction distance between the inner surface of the first groove portion 110 and the outer surface of the charging adapter 200.

In accordance to the end of the first protrusion 520 being disposed in the first groove of the charging connector, when/if the charging connector 100 is merely detached, the first groove 110 may not be able move in the x-axis direction due to the first protrusion 520. That is, the charging connector 100 may be fixedly coupled to the charging adapter 200 by the first protrusion 520.

Referring to FIG. 6, when/if an external z-axis directional compression force is applied to the spring 400, the first protrusion 520 rotates about the hinge pin 300 (e.g., counterclockwise in the drawing), and, accordingly, the end of the first protrusion 520 may moves outward from the inner surface of the connector connection portion 210.

Since the end of the first protrusion 520 is no longer disposed in the first groove portion 110 of the charging connector 100, the charging connector 100 may be in a detachable state. If/when the charging connector 100 is mounted/being mounted, the latch 500 may be pressed due to the first side surface 521-1 of the first protrusion 520 as described herein.. It may not be necessary to separately press the latch 500 to mount. However, in the case of detachment, the latch 500 may be pressed to remove at least a portion of the first protrusion 520 from the inside of the first groove portion 110, which may allow for removing the charging connector 100.

Referring to FIG. 7 illustrating a case where there is a forced detaching action of the charging connector 100, the charging connector 100 may be moved in the x-axis direction by the forced detaching action (e.g., unlike FIG. 5). As the charging connector 100 moves in the x-axis direction, the first groove portion 110 pushes the first protrusion 520 disposed therein in the x-axis direction, and accordingly, the latch 500 also moves in the x-axis direction. As described herein, since the hinge hole 222 is a hole extending in length in the x-axis direction, the hinge hole 222 may not physically interfere with the movement of the latch 500 in the x-axis direction.

As the latch 500 moves in the x-axis direction (e.g., without an external force applied to the spring 400, such as pressing the latch 500 by a user), the stopper 522 positioned on the first protrusion 520 also moves in the x-axis direction (e.g., without moving in the z-direction). At a position moved by a predetermined distance in the x-axis direction (e.g., defined by the length of the hinge hole 222 in the x-direction), the stopper 522 may be disposed inside the second groove portion 202 recessed in the x-axis direction of the charging adapter 200 (e.g., in the detachment direction of the charging connector 100). For example, the charging adapter 20 may include the second groove portion 202 into which the stopper 522 may be inserted based on (e.g., after) moving in the x-axis direction. The second groove portion 202 may be formed by at least a portion of the latch receiving portion 220 and at least a portion of the connector connection portion 210. Also, or alternatively, the second groove portion 202 may be an empty space between the connector connection portion 210 and the receiving portion 220 of the latch 500.

The height of the second groove 202 in the z-axis direction (e.g., from the outer surface of the charging adapter 200) may be less than or equal to the height of the first protrusion 520 in the z-axis direction from the protruding start surface thereof (e.g., the upper surface of the second protrusion 530) where the stopper 522 is positioned. The z-axis direction height of the second groove portion 202 may be greater than the z-axis direction height of the stopper 522 (e.g., such that the second groove portion 202 may be configured to accommodate the stopper 522).

The coupling of the stopper 522 and the second groove part 202 may prevent the forcible detachment of the charging connector 100. The movement of the charging connector 100 in the-x-axis direction (e.g., without an external force applied to the spring 400) may be blocked by the interaction between the first protrusion 520 and the first groove portion 110. However, in the structure of the latch 500 rotated by the hinge pin 300, the force of the first groove portion 110 pushing the first protrusion 520 may cause the first protrusion 520 of the latch 500 to move in the −z-axis direction. The stopper 522 and the second groove portion 202 may prevent the first protrusion 520 from moving in the −z-axis direction.

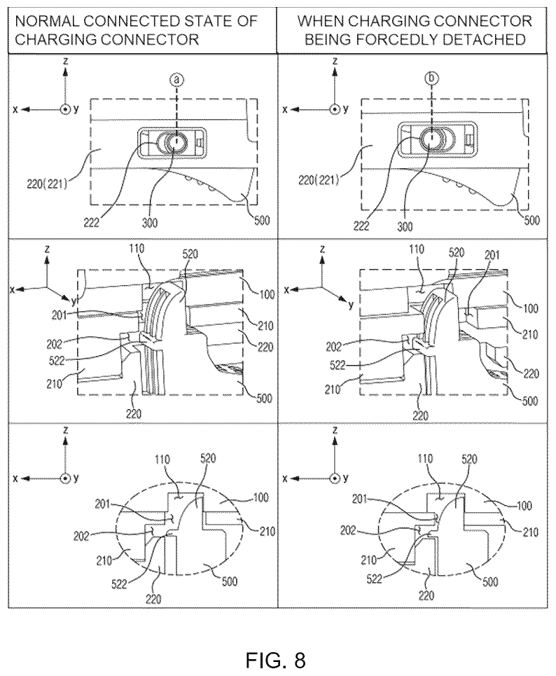

Referring to FIG. 8, which compares the situation of FIG. 5 with the situation of FIG. 7, a left side of the chart shows a state in which there is no forcible detaching action (e.g., that is a state in which the charging connector 100 shown in FIG. 5 is normally connected), and a right side of the chart shows a state in which there is forcible detaching action of the charging connector 100 shown in FIG. 7.

In a state in which the charging connector 100 is normally connected, the hinge pin 300 is positioned at the position (a) (e.g., the-x-axis direction end of the hinge hole 222), and only the end of the first protruding portion 520 and the first groove portion 110 remain coupled to each other. That is, since the stopper 522 is not coupled to the second groove 202, when a force is applied to the spring 400, the first protrusion 520 may move in the −z-axis direction.

However, when/if the charging connector 100 is forcibly detached (e.g., moved in the x-direction without an external force applied to the spring 400 and/or without otherwise rotating the latch 500), the first groove portion 110 may push the first protrusion 520 in the x-axis direction based on the charging connector 100 being moved in the x-axis direction. The latch 500 may also be moved in the x-axis direction due to the movement of the first portion 110 pushing the first protrusion 520. Accordingly, the hinge pin 300 may be located at the position \textcircled{b} e.g., the end of the hinge hole 222 in the x-axis direction), and the stopper 522 may be coupled to the second groove portion 202. The coupling of the stopper 522 in the second groove 202 may prevent the first protrusion 520 from moving in the −z-axis direction, thereby preventing the charging connector 100 from being forcibly detached from the charging adapter 200.

As described above, the charging adapter 200 and the latch 500 mounted thereon, according to the present disclosure, can prevent, using a simple structure, the charging connector 100 from being forcibly detached. The detachment prevention function may be released by simple/easy pressing of the latch 500, so that the user can use the detachment prevention function without having to checking the locked state of the button, thereby increasing user convenience.

The present disclosure provides a charging adapter equipped with an improved structure for preventing forced detachment of a charging connector.

According to the present disclosure, a user can conveniently perform a function of preventing forced detachment of a charging connector with only a simple push operation without moving, sliding and/or rotating to check the locking state.

According to the present disclosure, the charging connector may be connected to the charging adapter even if the locking button is not in the open state, and the charging connector may be prevented from being forcibly detached even if the locking button is not in the locked state.

The technical problems to be solved by the present disclosure are not limited to the technical problems mentioned herein. Other technical problems not mentioned will be clearly understood by a person of ordinary skill in the art in light of the present disclosure.

In an example, a charging adapter for a vehicle comprises a connector connection portion configured to provide a space where a charging connector is connected to the connector connection portion and received, a latch receiving portion disposed on an outer surface of the connector connection portion, a latch at least partially received in the latch receiving portion and hinge-coupled to the latch receiving portion by a hinge pin, and a spring disposed between one side of the latch and the latch receiving portion to push the latch and the latch receiving portion from one against the other, wherein the latch includes a first portion connected to the spring and a second portion comprising a first protrusion protruding in a first direction toward the connector connection portion, the first portion positioned oppositely to the second portion with respect to the hinge pin, and wherein the first protrusion penetrates the latch receiving portion and the connector connection portion and an end of the first protrusion is coupled to a first groove of the charging connector.

For example, the latch receiving portion and the connector connection portion may include a through-hole through which the first protrusion passes.

For example, the end of the first protrusion may be configured to move outward from an inner surface of the connector connection portion when pressure is applied to the spring.

For example, the latch may comprise a body extending in a second direction parallel to a connection direction of the charging connector and to which the hinge pin is connected and a spring fixing portion configured to fix the spring to one side of the body, and wherein the first protrusion is positioned on the other side of the body.

For example, the body may include a rotation shaft hole extending in a third direction horizontally perpendicular to the second direction to receive the hinge pin, and wherein the rotation shaft hole is disposed at a position closer to the spring fixing portion than the first protrusion.

For example, the first direction and the second direction may be perpendicular to each other.

For example, the latch may further comprise a second protrusion protruding from an end portion of the body in the second direction.

For example, an end of the second protruding portion may be located outside the latch receiving portion.

For example, a first side surface of the first protrusion facing a mounted direction of the charging connector may comprise a stopper protruding in a detachment direction of the charging connector.

For example, the first side surface may have a curved shape that is curved gentler as located closer to the opposite side surface.

For example, the latch receiving portion may comprise a hinge hole receiving both ends of the hinge pin therein, and the hinge hole has a length extending in the mounted direction or the detachment direction so that the hinge pin moves a predetermined distance in the mounted direction or the detachment direction.

For example, the latch receiving portion may comprise side walls extending in the mounted direction, at least a portion of the latch is disposed between the side walls, and the hinge hole is formed on the side walls.

For example, the charging adapter may comprise a second groove recessed in the detachment direction.

For example, the stopper may be disposed in the second groove portion when the latch is moved by a predetermined distance in the detachment direction.

For example, the second groove portion may be formed by at least a portion of the latch receiving portion and at least a portion of the connector connection portion.

For example, a length of the first protrusion in the first direction may be greater than a length in the first direction between an inner surface of the connector connection portion and an outer surface of the charging adapter and may be less than or equal to a length in the first direction between an inner surface of the first groove portion and the outer surface of the charging adapter.

In an example, a vehicle may comprise a charging adapter as described herein.

According to the present disclosure, the function of preventing the forced removal of the charging connector can be conveniently performed by a simple push operation without the need for the user to check and move or rotate the locking state of the lock button.

The charging connector may be connected to the charging adapter even if the lock button is not in the open state, and the charging connector may be prevented from being forcibly removed even if the lock button is not in the locked state.

Effects obtainable from the present disclosure are not limited to the effects mentioned herein, and other effects not mentioned will be clearly understood by those skilled in the art from the present description.

While specific examples of the present disclosure are described herein, various other forms of implementation are possible. The technical contents described herein may be combined in various forms and/or replaced with equivalents without departing from the scope of the present disclosure.

It will be obvious to those skilled in the art that the present disclosure may take other specific forms without departing from the idea and essential features of the present disclosure. Accordingly, the above detailed description should not be construed as limiting in all respects and should be considered as illustrative. The scope of the present disclosure should be determined by reasonable interpretation of the appended claims, and all changes/variations within the equivalent scope of the present disclosure are included in the scope of the present disclosure.

What is claimed is

1. A charging adapter for a vehicle, the charging adapter comprising:
a connector port that forms a space configured to accept insertion of a charging connector;
a latch holder on an outer surface of the connector port;
a latch configured to be at least partially received in the latch holder;
a hinge pin that hinge-couples the latch to the latch holder; and
a spring disposed between a first side of the latch and the latch holder,
wherein the latch comprises:
a first portion connected to the spring, and
a second portion comprising a first protrusion protruding in a first direction toward the connector port, the first portion positioned oppositely to the second portion with respect to the hinge pin, and
wherein the first protrusion is configured to penetrate the latch holder and the connector port, and an end of the first protrusion is configured to be inserted into a first groove of the charging connector.

2. The charging adapter of claim 1, wherein the latch holder and the connector port form a through-hole through which the first protrusion passes.

3. The charging adapter claim 1, wherein the end of the first protrusion is configured to move, based on an external pressure applied to the spring, outward from an inner surface of the connector port.

4. The charging adapter of claim 1, wherein the latch comprises a body, extending in a second direction parallel to a connection direction of the charging connector, to which the hinge pin is connected and wherein the spring is fixed to a spring fixing portion of the body positioned on a first side of the body, and wherein the first protrusion is positioned on a second side of the body opposite to the first side of the body relative to the hinge pin.

5. The charging adapter of claim 4, wherein the body forms a rotation shaft hole, extending in a third direction perpendicular to the second direction and the first direction, configured to receive the hinge pin, and wherein the rotation shaft hole is disposed at a position closer to the spring fixing portion than to the first protrusion.

6. The charging adapter of claim 4, wherein the first direction and the second direction are perpendicular to each other.

7. The charging adapter of claim 4, wherein the latch further comprises a second protrusion protruding from an end portion of the body in the second direction.

8. The charging adapter of claim 7, wherein an end of the second protrusion extends in the second direction outside the latch holder.

9. The charging adapter of claim 1, wherein a first side surface, of the first protrusion, facing a detachment direction of the charging connector comprises a stopper protruding in the detachment direction of the charging connector.

10. The charging adapter of claim 9, wherein the first side surface has a curved shape that is curved more steeply as it approaches the opposite side surface.

11. The charging adapter of claim 9, wherein the latch holder forms hinge holes each having a length extending in a second direction parallel to the detachment direction so that the hinge pin is able to move a predetermined distance in the second direction.

12. The charging adapter of claim 11, wherein the latch holder comprises side walls extending in the second direction, wherein at least a portion of the latch is disposed between the side walls, and wherein the hinge holes are formed in the side walls.

13. The charging adapter of claim 11, wherein the charging adapter comprises a second groove recessed in the detachment direction.

14. The charging adapter of claim 13, wherein the stopper is configured to be inserted, based on the hinge pins moving in the detachment direction, in the second groove.

15. The charging adapter of claim 13, wherein the second groove is formed by at least a portion of the latch holder and at least a portion of the connector port.

16. The charging adapter of claim 12, wherein a length of the first protrusion in the first direction is:
greater than a length, in the first direction, between an inner surface of the connector port and an outer surface of the charging adapter, and
less than or equal to a length, in the first direction, between an inner surface of the first groove and the outer surface of the charging adapter.

17. A vehicle comprising a charging adapter, wherein the charging adapter comprises:
a connector port that forms a space configured to accept insertion of a charging connector;
a latch holder on an outer surface of the connector port;
a latch configured to be at least partially received in the latch holder;
a hinge pin that hinge-couples the latch to the latch holder; and
a spring disposed between a first side of the latch and the latch holder,
wherein the latch comprises:
a first portion connected to the spring; and
a second portion comprising a first protrusion protruding in a first direction toward the connector port, the first portion positioned oppositely to the second portion with respect to the hinge pin; and
wherein the first protrusion is configured to penetrate the latch holder and the connector port, and an end of the first protrusion is coupled to a first groove of the charging connector.

18. The vehicle of claim 17, wherein the first protrusion is configured to pass through a through-hole formed by the latch holder and the connector port.

19. The vehicle of claim 17, wherein the latch comprises:
a body, extending in a second direction parallel to a connection direction of the charging connector, to which the hinge pin is connected, and
a spring fixing portion configured to fix the spring to a first side of the body, wherein the first protrusion is positioned on a second side of the body opposite to the first side of the body.

20. A charging adapter for a vehicle, the charging adapter comprising:
a connector port that forms a space configured to accept insertion of a charging connector;
a latch hingedly fixed to a side of the connector port via a hinge pin having ends inserted in hinge holes formed in the side of the connector port;
a spring disposed between a first side of the latch and the side of the connector port,
a first protrusion, on a second side of the latch opposite to the first side, protruding in a first direction toward the connector port, wherein the first protrusion is configured to penetrate the connector port, and an end of the first protrusion is configured to be inserted into a first groove of the charging connector; and
a second protrusion, on a side of the first protrusion, protruding in a second direction toward a groove formed by the connector port, wherein the hinge holes have a length in the second direction configured to allow the hinge pin to move in the second direction such that the second protrusion is inserted into the groove.
